(19) United States
(12) Patent Application Publication
(10) Pub. No.: US 2026/0021566 A1
(43) Pub. Date: Jan. 22, 2026

(54) OUTER RING DRIVE PLANETARY GEAR ASSEMBLY

(71) Applicant: MILWAUKEE ELECTRIC TOOL CORPORATION, Brookfield, WI (US)

(72) Inventors: Kentez L. Craig, Milwaukee, WI (US); Amith J. Baskaran, Menomonee Falls, WI (US); Andrew R. Palm, Glendale, WI (US); Jordan P. Gilsinger, Sussex, WI (US)

(21) Appl. No.: 18/997,160

(22) PCT Filed: Jul. 20, 2023
(86) PCT No.: PCT/US2023/070567

§ 371 Date: Jan. 20, 2025

Related U.S. Application Data
(60) Provisional application No. 63/390,805, filed on Jul. 20, 2022.

(51) Int. Cl. B25F 5/00; B25B 21/02; F16H 1/28

(52) U.S. Cl. CPC B25F 5/001; F16H 1/28; B25B 21/026

(57) ABSTRACT

A tool is disclosed and includes a housing, a motor within the housing, wherein the motor includes a support bracket with a stator disposed thereon and a rotor rotatable disposed around the stator, a gear assembly within the housing and operatively coupled to the motor, wherein the gear assembly includes a sun gear, a plurality of planet gears disposed on a planet gear carrier around the sun gear, and an outer ring gear surrounding the planet gears, wherein the outer ring gear is affixed to the rotor of the motor to rotate therewith.

### CROSS-REFERENCE TO RELATED APPLICATIONS

This application claims priority to co-pending U.S. Provisional Patent Application No. 63/390,805 filed on Jul. 20, 2022, the entire content of which is incorporated herein by reference.

### FIELD OF THE INVENTION

The present invention relates to power tools, and more specifically to impact tools.

### BACKGROUND OF THE INVENTION

Impact tools, such as impact drivers and impact wrenches, are typically utilized to provide a striking rotational force, or intermittent applications of torque, to a tool element or workpiece (e.g., a fastener) to either tighten or loosen the fastener.

### SUMMARY OF THE INVENTION

The present invention provides, in one aspect, a tool that includes a housing, a motor within the housing, wherein the motor includes a support bracket with a stator disposed thereon and a rotor rotatable disposed around the stator, a gear assembly within the housing and operatively coupled to the motor, wherein the gear assembly includes a sun gear, a plurality of planet gears disposed on a planet gear carrier around the sun gear, and an outer ring gear surrounding the planet gears, wherein the outer ring gear is affixed to the rotor of the motor to rotate therewith.

The present invention provides, in another aspect, a tool includes a housing, a motor within the housing, wherein the motor includes a support bracket with a stator disposed thereon and a rotor rotatable disposed around the stator, a gear assembly within the housing and operatively coupled to the motor, wherein the gear assembly includes a rotating sun gear, a plurality of planet gears disposed on a fixed planet gear carrier around the sun gear, and an outer ring gear surrounding the planet gears, wherein the outer ring gear is affixed to the rotor of the motor to rotate therewith and as the rotor and the outer ring gear rotates, the sun gear rotates within the fixed planet gear carrier.

The present invention provides, in yet another aspect, a drive assembly for a tool and the drive assembly includes a motor housing, a support bracket extending at least partially into the motor housing, a stator disposed on the support bracket within the motor housing, a fixed sun gear disposed on the support bracket within the motor housing, a rotating planet gear carrier disposed around the sun gear, a plurality of planet gears disposed on the rotating planet gear carrier, wherein the plurality of planet gears rotate around the sun gear as the rotating planet gear carrier rotates, a rotating outer ring gear surrounding the planet gears, and a rotor surrounding the stator, wherein the rotor is affixed to the rotating outer ring gear carrier and the rotating outer ring gear carrier rotates with the rotor when the motor is energized.

Other features and aspects of the invention will become apparent by consideration of the following detailed description and accompanying drawings.

### BRIEF DESCRIPTION OF THE DRAWINGS

FIG. 1 is a perspective view of an impact tool according to one embodiment.

FIG. 2 is a front view of the impact tool of FIG. 1.

FIG. 3 is a side view of the impact tool of FIG. 1.

FIG. 4 is a cross-sectional view of the impact tool of FIG. 1, taken along line 4-4 in FIG. 2.

FIG. 5 is a cross-sectional view of the impact tool of FIG. 1, taken along line 5-5 in FIG. 3.

FIG. 6 is a schematic view of an alternative drive assembly.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

As described in greater detail below, the present disclosure provides, in some aspects, a power tool including a motor with a stator and a rotor surrounding the stator. The rotor is configured to drive an outer ring gear of a planetary transmission. The planetary transmission includes a sun gear that is coupled to a camshaft or spindle of the power tool. This arrangement may reduce the overall length of the tool, as the planetary transmission may be positioned rearward of the motor, and the camshaft or spindle may extend at least partially through the motor. In addition, this ring gear may act as a flywheel to advantageously add rotational inertia to the tool and, in the case of an impact tool, increase an impact force and associated fastening torque of the tool.

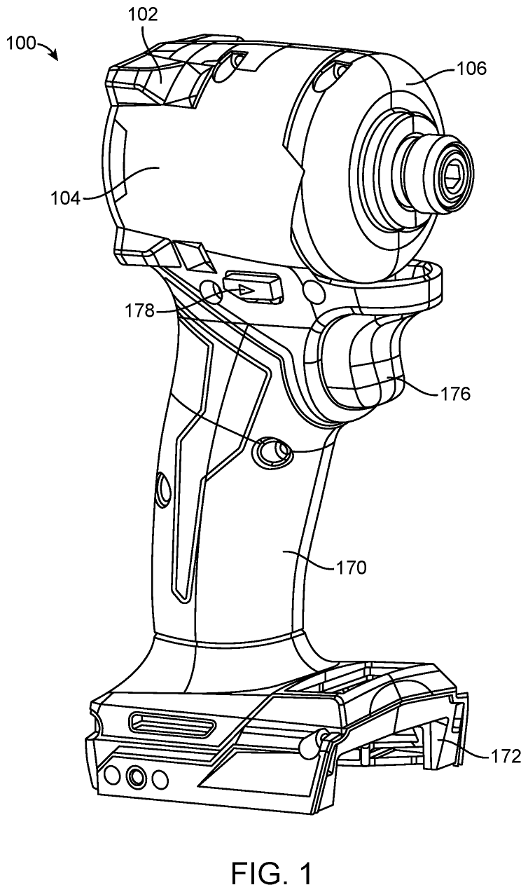

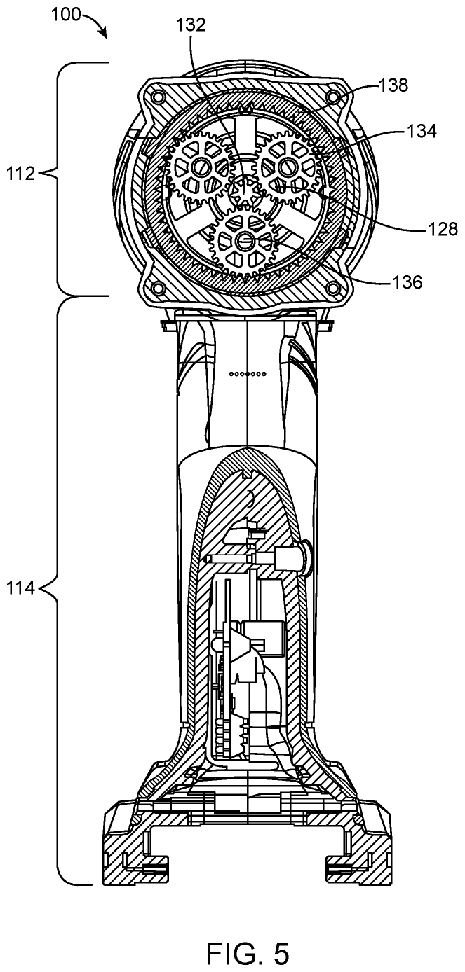

For example, referring to FIG. 1-FIG. 5, a power tool is illustrated and is generally designated 100. As shown, the power tool is a rotary impact tool 100 (i.e. an impact driver). Specifically, the power tool is a battery powered rotary impact tool 100. As illustrated in FIG. 1, the rotary impact tool 100 includes a housing 102 that has a first housing side 104 and a second housing side 106. As shown in FIG. 1, the housing sides 104, 106 meet to form an interface 108 between the housing sides 104, 106. It is to be understood that the housing sides 104, 106 are cooperating clamshell halves that are attached, or otherwise affixed, to each other via a plurality of fasteners 110, e.g., screws. Alternatively, the housing sides 104, 106 are affixed to each other via an adhesive or via a plastic welding operation, or in any other suitable manner.

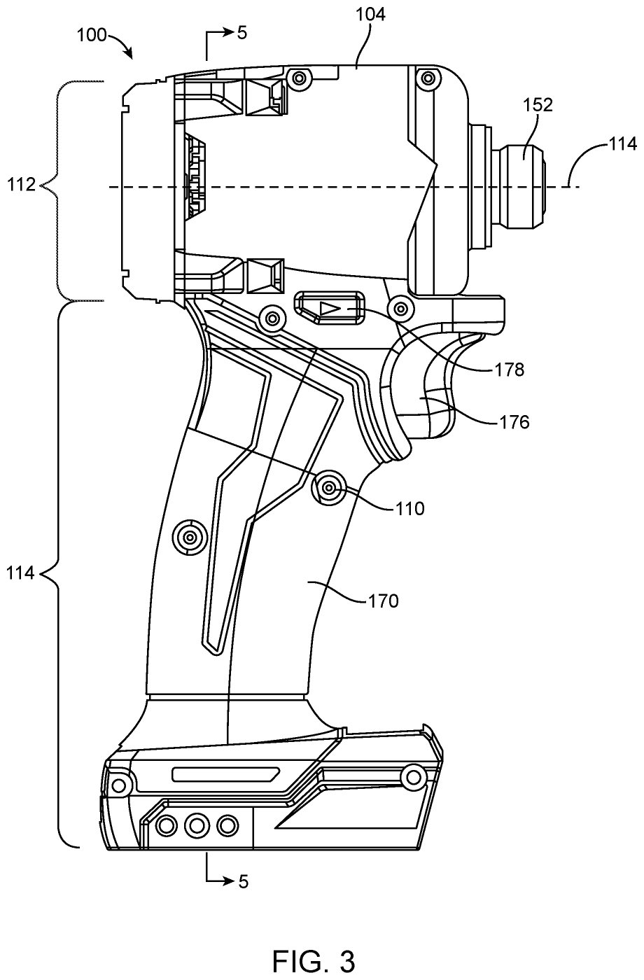

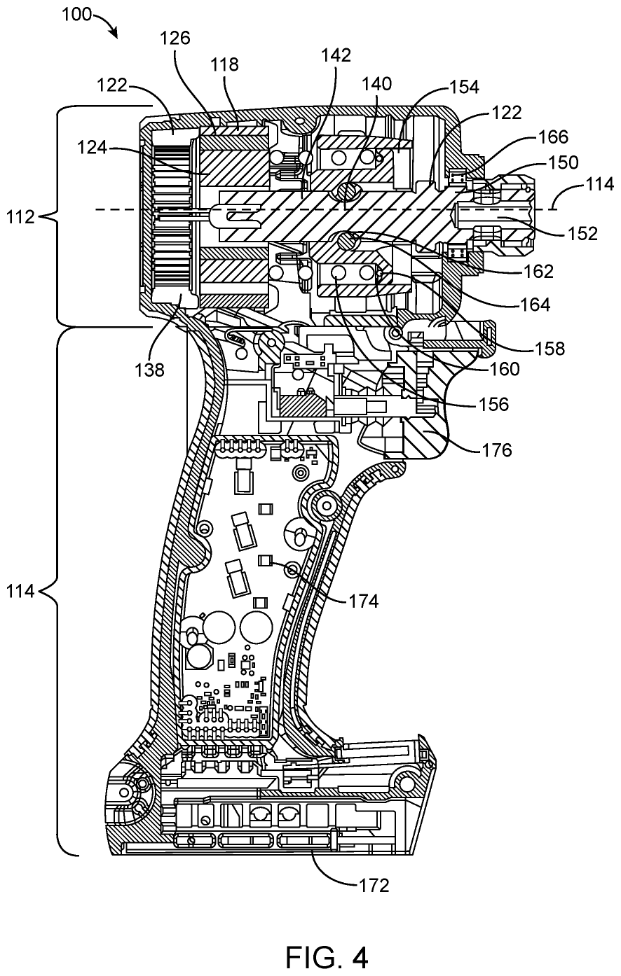

As depicted in FIGS. 3-4, the housing 102 includes a drive portion 112 that defines a drive axis 114. The housing 102 also include a handle portion 116 that extends in a generally perpendicular direction from the drive axis 114. The drive portion 112 of the housing 102 includes a motor 118 operatively coupled to a gear assembly 120 (FIG. 4). The gear assembly 120 is operatively coupled to a drive assembly 122. The illustrated motor 118 is a brushless direct current (“BLDC”) motor having a rotor 124 surrounding a stator 126. As such, the illustrated motor 118 may be referred to as an outer-rotor motor.

As shown in FIG. 4, the illustrated gear assembly 120 includes a sun gear 132. A plurality of planet gears 134 is meshed with the sun gear 132 and supported via pins coupled to a stationary planet gear carrier 136. An outer ring gear 138 surrounds the planet gears 134 and is meshed with the planet gears 134. The outer ring gear 138 rotates within drive portion 112 and is affixed to the outer rotor 124 of the motor 118. Accordingly, as the outer ring gear 138 rotates in one direction (directly driven by the rotor 124 of the motor 118), planet gears 134 rotate about their respective pins and drive the sun gear 132. Thus, the gear assembly 120 provides a speed reduction and torque increase from the rotor 124 and the outer ring gear 138 to the sun gear 132.

In the illustrated embodiment, the gear assembly 120 is positioned rearward of the motor 118 along the axis 114. This may advantageously result in a more compact overall size of the impact tool 100. In other embodiments, however, the gear assembly 120 may be positioned in front of the motor 118 or elsewhere within the impact tool 100.

With reference to FIG. 4, the illustrated drive assembly 122 includes a camshaft 140 and a connecting shaft 142 that extends between and interconnects the camshaft 140 and the sun gear 132, such that the camshaft 140 co-rotates with the sun gear 132. In some embodiments, the camshaft 140 may extend at least partially through the center of the stator 126. In such embodiments, the connecting shaft 142 may be omitted, and the camshaft 140 may be directly coupled to the sun gear 132, or integrally formed with the sun gear 132.

The rotor 124 of the motor 118 is affixed to the outer ring gear 138. For example, the outer ring gear 138 may be press fit around the rotor 124. Alternatively, the rotor 124 may be press fit around the outer ring gear 138. In another embodiment, a face of the rotor 124 may be affixed to a face of the outer ring gear 138 via one or more fasteners, an adhesive, or a welding operation. The fasteners may include pins, screws, rivets, or other mechanical fasteners. In another embodiment, the rotor 124 and the outer ring gear 138 may be formed as a single monolithic piece, e.g., via a molding operation, via additive manufacturing, or via powdered metal processing, such as compaction and sintering. Thus, rotation of the rotor 124 rotates the outer ring gear 138, which then transmits torque to the sun gear 132 (and ultimately the camshaft 140) via the planet gears 134.

With continued reference to FIG. 4, the drive assembly 122 of the impact tool 100 includes an anvil 150 extending from the housing 102 with a bit holder 152 to which a tool element (e.g., a screwdriver bit, a socket bit, etc.; not shown) can be coupled for performing work on a workpiece (e.g., a fastener). The anvil 150 is rotatably supported by a bearing 166 fixed within a front portion of the housing 102. The drive assembly 122 is configured to convert the continuous rotational force or torque provided by the motor 118 and gear assembly 120 to a striking rotational force or intermittent applications of torque to the anvil 150 when the reaction torque on the anvil 150 (e.g., due to engagement between the tool element and a fastener being worked upon) exceeds a certain threshold. In the illustrated embodiment of the impact tool 100, the drive assembly 122 includes the camshaft 140, a hammer 154 supported on and axially slidable relative to the camshaft 140, and the anvil 150.

With continued reference to FIG. 4, the drive assembly 122 further includes a spring 156 biasing the hammer 154 toward the front of the impact tool 100 (i.e., toward the right in FIG. 4). In other words, the spring 156 biases the hammer 154 in an axial direction toward the anvil 150, along the axis 114. A thrust bearing 158 and a thrust washer 160 are positioned between the spring 156 and the hammer 154. The thrust bearing 158 and the thrust washer 160 allow for the spring 156 and the camshaft 140 to continue to rotate relative to the hammer 154 after each impact strike when lugs on the hammer 154 engage with corresponding anvil lugs and rotation of the hammer 154 momentarily stops.

The camshaft 140 further includes cam grooves 162 in which corresponding cam balls 164 are received. The cam balls 164 are in driving engagement with the hammer 154 and movement of the cam balls 164 within the cam grooves 162 allows for relative axial movement of the hammer 154 along the camshaft 140 when the hammer lugs and the anvil lugs are engaged and the camshaft 140 continues to rotate.

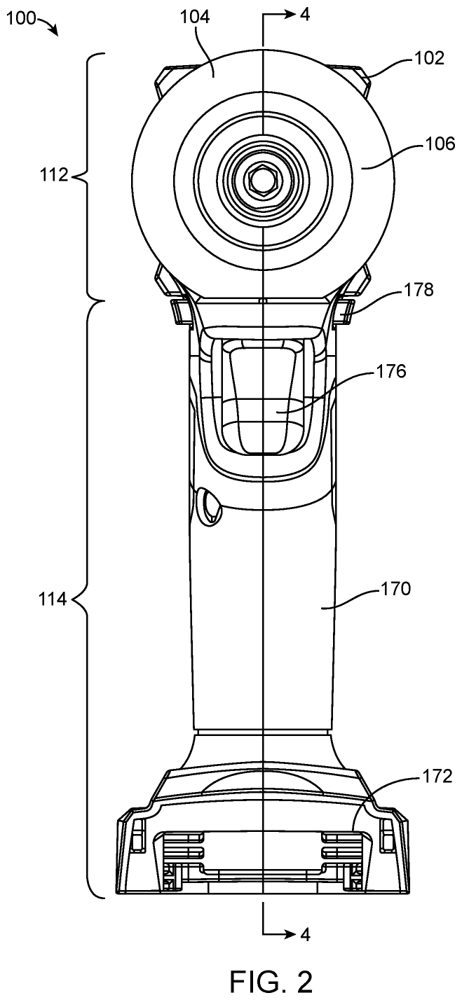

FIGS. 1-5 further show that the handle portion 116 of the impact tool 100 includes a grip 170. Further, the handle portion 116 includes a battery receptacle 172 that is configured to receive a removable battery pack to provide power to the motor 118. A circuit board 174 is disposed within the handle portion 116 and includes the electronics that control the operation of the impact tool 100 (FIG. 4). The handle portion 116 also includes a trigger 176 that is actuatable to selectively energize the motor 118. FIGS. 2 and 3 further show that the impact tool 100 includes a direction selector button 178 that extends laterally through the housing 102. The direction selector button 178 allows an operator of the impact tool 100 to change the direction of rotation of the output shaft 130.

To operate the impact tool 100, an operator depresses the trigger 176 to activate the motor 118, which continuously drives the gear assembly 120 and the camshaft 140 via the outer rotor 124. As the camshaft 140 rotates, the cam balls 164 drive the hammer 154 to co-rotate with the camshaft 140, and the hammer lugs engage, respectively, driven surfaces of the anvil lugs to provide an impact and to rotatably drive the anvil 150 and the tool element.

After each impact, the hammer 154 moves or slides rearward along the camshaft 140, away from the anvil 150, so that the hammer lugs disengage the anvil lugs. As the hammer 154 moves rearward, the cam balls 164 situated in the respective cam grooves 162 in the camshaft 140 move rearward in the cam grooves 162. The spring 156 stores some of the rearward energy of the hammer 154 to provide a return mechanism for the hammer 154. After the hammer lugs disengage the respective anvil lugs, the hammer continues to rotate and moves or slides forwardly, toward the anvil 150, as the spring 156 releases its stored energy, until the drive surfaces of the hammer lugs re-engage the driven surfaces of the anvil lugs to cause another impact.

Although the rotor 124 is shown incorporated in a rotary impact tool 100, the rotor 124 may alternatively be used with other rotary power tools (e.g., drills, reciprocating saws, rotary hammers, pulse drivers, etc.). Driving the outer ring gear 138 via the rotor 124, as described herein, may also provide a greater moment of inertia during impacts of the impact tool 100. More specifically, the outer ring gear 138 may act as a flywheel to increase the rotational inertia of the rotor 124.

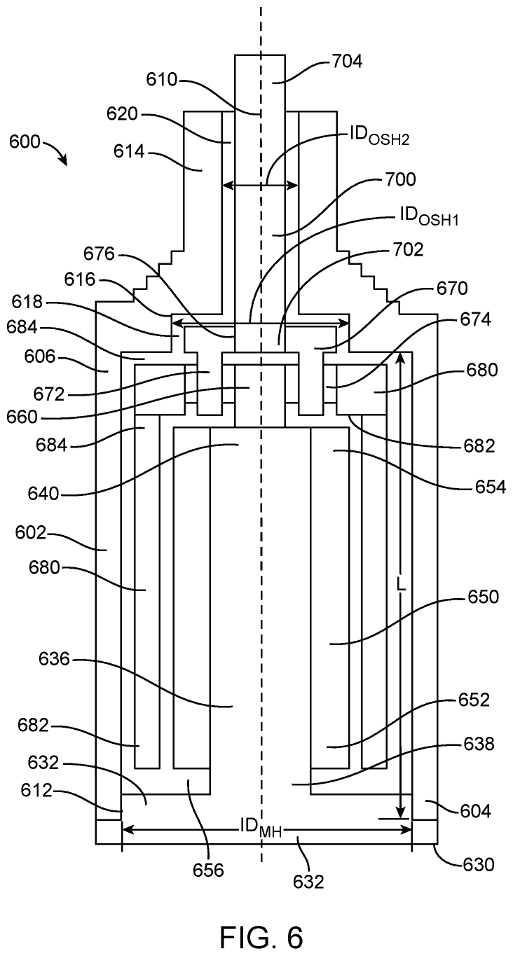

FIG. 6 illustrates an embodiment of a drive assembly 600. The drive assembly 600 may be used within the impact tool 100, described above, a powered ratchet, a powered screwdriver, a drill, or other power tool. It is to be understood that the drive assembly 600 may be installed within the drive portion 112 of the housing 102 of the impact tool 100.

As illustrated the drive assembly 600 includes a generally cylindrical motor housing 602 which includes a proximal end 604 and a distal end 606. The motor housing 602 also includes central bore 608 that defines a motor housing length L_{MH} and a motor housing internal diameter ID_{MH}. The motor housing internal diameter D_{MH} is substantially the same along the length L_{MH} of the motor housing 602, i.e., from the proximal end 604 to the distal end 606 of the motor housing 602. FIG. 6 further indicates that the drive assembly 600 includes a longitudinal axis 610 that extends through the center of the drive assembly 600.

As further shown in FIG. 6, the proximal end 604 of the motor housing 602 is formed with an opening 612. Moreover, an output shaft housing 614 extends from the distal end 606 of the motor housing 602 and includes an internal bore 616 having a first portion 618 and a second portion 620. The first portion 618 of the internal bore 616 has a first internal diameter ID_{OSH1} and the second portion 620 of the internal bore 616 has a second internal diameter ID_{OSH2}. In particular, the first internal diameter ID_{OSH1} of the first portion 618 of the internal bore 616 of the output shaft housing 614 is less than the motor housing internal bore ID_{MH}. Moreover, the second internal diameter ID_{OSH2} of the second portion 620 of the internal bore 616 of the output shaft housing 614 is less than the first internal diameter ID_{OSH1} of the first portion 618 of the internal bore 616 of the output shaft housing 614.

FIG. 6 further shows a support bracket 630 at least partially disposed in the opening 612 formed in the proximal end 604 of the motor housing 602. The support bracket 630 extends at least partially into the motor housing 602 and includes a generally disc-shaped base 632 with a central hub 634 extending therefrom. The central hub 634 is sized and shaped to fit into and fully enclose the opening 612 formed in the proximal end 604 of the motor housing 602. A central support post 636 extends from the central hub 634 of the support bracket 630 and extends at least partially into the central bore 608 of the motor housing 602 along the longitudinal axis 610 of the drive assembly 600. The central support post 636 includes a proximal end 638 and a distal end 640. The proximal end 638 is affixed to, or monolithically formed with, the hub 634 of the support bracket 630. The distal end 640 is a free end and extends into an area within the central bore 608 adjacent the distal end 606 of the motor housing 602.

As illustrated in FIG. 6, a stator 650 is disposed on, and affixed to, the central support post 636 of the support bracket 630 within the motor housing 602. The stator 650 extends along the length of the support bracket 630 from the proximal end 638 of the support bracket 630 to the distal end 640 of the support bracket 630. The stator 650 includes a proximal end 652 near the proximal end 638 of the support post 636 and a distal end 654 near the distal end 640 of the support post 636. The proximal end 652 of the stator 650 is spaced apart from the central hub 634 of the support bracket 630 so that a gap 656 is formed between the proximal end 652 of the stator 650 and the central hub 634 of the support bracket 630.

FIG. 6 further indicates that a sun gear 660 is affixed to the distal end 640 of the support post 636 of the support bracket 630 within the motor housing 602. The sun gear 660 is fixed and therefore, does not rotate or translate with respect to the central support post 636, the support bracket 630, or the motor housing 602. In a particular aspect, the sun gear 660 is affixed to a face of the distal end 640 of the support post 636 of the support bracket 630 via one or more fasteners, an adhesive, or a welding operation. The fasteners may include pins, screws, rivets, or other mechanical fasteners. In another embodiment, the sun gear 660 and the central support post 636 may be formed as a single piece, e.g., via a molding operation, via additive manufacturing, or via powdered metal processing, such as compaction and sintering. Further, the distal end 640 of the central support post 636 of the support bracket 630 may be machined with teeth to form the sun gear 660 thereon. It is to be understood that in this embodiment, the sun gear 660 does not rotate.

As further shown in FIG. 6, a rotating planet gear carrier 670 is disposed around the sun gear 660. The planet gear carrier 670 has a plurality of gear support posts 672 and each gear support post 672 has a planet gear 674 disposed thereon. As such, the planet gear carrier 670 includes, and supports, a plurality of planet gears 674 disposed around and engaged with the sun gear 660. The planet gears 674 rotate around the sun gear 660. The planet gear carrier 670 further includes a central bore 676 formed therein.

FIG. 6 further shows a rotating outer ring gear 680 surrounds the planet gears 674. The rotating outer ring gear 680 incudes a proximal face 682 and a distal face 684. A rotor 690 is affixed to the outer ring gear 680 and includes a proximal end 692 and a distal end 694. Specifically, the distal end 694 of the rotor 690 is affixed to the proximal face 682 of the outer ring gear 680. In particular, the distal end 694 of the rotor 690 may be affixed to the proximal face of the outer ring gear 680 via one or more fasteners, an adhesive, or a welding operation. The fasteners may include pins, screws, rivets, or other mechanical fasteners. In another aspect, the rotor 690 and the outer ring gear 680 may be formed as a single piece, e.g., via a molding operation, via additive manufacturing, or via powdered metal processing, such as compaction and sintering. Thus, when motor is energized and the rotor 690 rotates, the outer ring gear 680 rotates and transmits torque to the planet gears 674 via the stationary sun gear 660.

As further shown in FIG. 6, the drive assembly 600 includes an output shaft 700 that extends from the planet gear carrier 670. The output shaft 700 includes a proximal end 702 and a distal end 704. The proximal end 702 of the output shaft 700 is affixed to the planet gear carrier 670 via a welding operation, a press-fit arrangement, or similar fixation method. For example, the proximal end 702 of the output shaft 700 is press fit into the central bore 676 of the planet gear carrier 670. Alternatively, the central bore 676 of the planet gear carrier 670 is formed with internal threads and the proximal end 702 of the output shaft 700 is formed with external threads. As such, the proximal end 702 of the output shaft 700 is threadably engaged with the central bore 676 of the planet gear carrier 670. It is to be understood when the planet gears 674 rotate, the planet gear carrier 670 rotates and the output shaft 700 rotates with the planet gear carrier 670. The distal end 704 of the output shaft 700 is sized and shaped to engage a tool therein or thereon. For example, the tool is a socket, a drill bit, a driver bit, another similar tool, or a combination thereof.

Although the invention has been described in detail with reference to certain preferred embodiments, variations and modifications exist within the scope and spirit of one or more independent aspects of the invention as described.

1. A tool, comprising:
a housing;
a motor within the housing, wherein the motor includes a support bracket with a stator disposed thereon and a rotor rotatable disposed around the stator;
a gear assembly within the housing and operatively coupled to the motor, wherein the gear assembly includes
a sun gear;
a plurality of planet gears disposed on a planet gear carrier around the sun gear; and
an outer ring gear surrounding the planet gears, wherein the outer ring gear is affixed to the rotor of the motor to rotate therewith.

2. The tool of claim 1, wherein the planet gear carrier is fixed and the sun gear rotates within the planet gears as the outer gear rotates on the planet gears.

3. The tool of claim 2, further comprising a shaft coupled to the sun gear, wherein the shaft rotates with the sun gear.

4. The tool of claim 1, wherein the sun gear is fixed and the planet gear carrier rotates as the planet gears rotate around the sun gear as the outer gear rotates and drives the planet gears.

5. The tool of claim 1, further comprising a shaft coupled to the planet gear carrier, wherein the shaft rotates with the planet gear carrier.

6. A tool, comprising:
a housing;
a motor within the housing, wherein the motor includes a support bracket with a stator disposed thereon and a rotor rotatable disposed around the stator;
a gear assembly within the housing and operatively coupled to the motor, wherein the gear assembly includes
a rotating sun gear;
a plurality of planet gears disposed on a fixed planet gear carrier around the sun gear; and
an outer ring gear surrounding the planet gears, wherein the outer ring gear is affixed to the rotor of the motor to rotate therewith, and wherein the sun gear rotates within the fixed planet gear carrier in response to rotation of the rotor and the outer ring gear.

7. The tool of claim 6, wherein a face of the rotor is affixed to a face of the outer ring gear via a plurality of mechanical fasteners.

8. The tool of claim 6, wherein a face of the rotor is affixed to a face of the outer ring gear via an adhesive.

9. The tool of claim 6, wherein a face of the rotor is affixed to a face of the outer ring gear via welding operation.

10. The tool of claim 6, wherein the outer ring gear and the rotor are molded as a single monolithic piece.

11. The tool of claim 6, wherein the rotor is press fit around the outer ring gear.

12. The tool of claim 6, further comprising a shaft coupled to the sun gear, wherein the shaft rotates with the sun gear.

13. A drive assembly for a tool, the drive assembly comprising:
a motor housing;
a support bracket extending at least partially into the motor housing;
a stator disposed on the support bracket within the motor housing;
a fixed sun gear disposed on the support bracket within the motor housing;
a rotating planet gear carrier disposed around the sun gear;
a plurality of planet gears disposed on the rotating planet gear carrier, wherein the plurality of planet gears rotate around the sun gear in response to rotation of the rotating planet gear carrier;
a rotating outer ring gear surrounding the planet gears; and
a rotor surrounding the stator, wherein the rotor is affixed to the rotating outer ring gear carrier and the rotating outer ring gear carrier rotates with the rotor when the motor is energized.

14. The drive assembly of claim 13, further comprising a shaft coupled to the rotating planet gear carrier, wherein the shaft rotates with the rotating planet gear carrier.

15. The drive assembly of claim 14, wherein the shaft is welded to the rotating plane gear carrier.

16. The drive assembly of claim 13, wherein the rotating planet gear carrier includes a central bore.

17. The drive assembly of claim 16, wherein the shaft is threadably engaged with the central bore of the rotating planet gear carrier.

18. The drive assembly of claim 16, wherein the shaft is press fit into the central bore of the rotating planet gear carrier.

19. The drive assembly of claim 13, wherein the shaft is configured to engage a tool.

20. The drive assembly of claim 19, wherein the tool is a socket, a drill bit, a driver bit, or a combination thereof.
